(19) United States
(12) Patent Application Publication
(10) Pub. No.: US 2020/0372093 A1
(43) Pub. Date: Nov. 26, 2020

(54) 1 Disphasing Warp Structure - is a substructure to all fields and particles and quanta 2 Quaternary structured "Realogs / Realogy" - a structure that assembles all warp structures 3 Intonation, a New Basic Unit for Data, reflects and is the 'four part structure' of fields and particles and quantum reality 4 Qualitative Mathematics System is a symbolic system representing the Disphasing Warp, and Realogy, and their functions

(71) Applicant: John Paul Sahagian, Libertyville, IL (US)

(72) Inventor: John Paul Sahagian, Libertyville, IL (US)

(21) Appl. No.: 16/419,890

(22) Filed: May 22, 2019

(51) Int. Cl. G06F 17/11; G06N 10/00

(52) U.S. Cl. CPC G06F 17/11; G06N 10/00

(57) ABSTRACT

Three inventions/discoveries of: 1. Warp, 2. Realogy, 3. Intonation operate at their core by their embedding in a ‘single unifying field’ throughout reality. Let's call it ‘Union’. Invention 4., Qualitative Mathematics, is a system of representation of that whole operation, for purposes of design and analysis and assisting functionality. Quantum computing and qubits function by this embedding. The structure of qubits can be designed into the language of computers, which can be made to mimic it using qualitative mathematics and intonation complexes. The physical structure of qubits in quantum computers is made of Warps and their Realogic structures, encoded and then measured by various devices. By this new understanding of entanglement's (qubit's) operation in reality as ‘relational software’, embodied in nature's bridge into the superposed state seen in ‘warps’ structure and function, and also seen in their complexes and relationships called ‘realogy’ structure, we can better construct physical mechanisms for quantum computing.

1. Disphasing Warp Structure—is a substructure to all fields and particles and quanta.

2. Quaternary structured “Realogs/Realogy”—a structure that assembles all warp structures.

3. Intonation, a New Basic Unit for Data, reflects and is the ‘four part structure’ of fields and particles and quantum reality.

4. Qualitative Mathematics System is a symbolic system representing the Disphasing Warp, and Realogy, and their functions.

### BACKGROUND OF THE INVENTION

The field of endeavor of the inventions is relevant to Quantum Computers, Quantum Entanglement, Quantum bits (qubits), a system of Qualitative Mathematics, a new Unit of Data for Quantum Superpositions, and reconciliation between Quantum mechanics and Relativity. The state of technology involved in that which is quantum computer related struggles with problems such as quantum states of qubits being fragile and hard to maintain for use in quantum logic operations used in carrying out algorithms in quantum computing. Holding the quantum state, or ‘coherence’, is difficult to do. Coherence errors are a problem for quantum computers. An additional problem is the scalability of producing them. References helpful in summarizing the problems in this technology, and also one in understanding my invention would be:

Katherine Bourzac, “Upgrading the quantum computer,” Chemical and Engineering News 97 (2019): 26-32., and

Johnpaul Sahagian, A New Physics, Warp and Realogy (of Macroscopic and Subatomic Reality), A Unified Field Reality and Theory of All Things, 2019, respectively.

I would be happy to provide an electronic copy of my 260 page book upon request. It is in the process of being copyrighted.

### BRIEF SUMMARY OF THE INVENTION

The first three inventions, 1. Disphasing Warps, 2. Quaternary Structured “Realogs/ Realogy,” and 3. a new Basic Unit of Data called an ‘intonation’, which is comparable to a unit of information, but is a conglomerate or complex (analogous to a superposition, or qubit) within reality structure and reflected in qualitative mathematics, all explain and elucidate the basis of Quantum Entanglement, and therefore the pathways to further development of quantum computers and reliable error free qubit production. 4. An additional invention is the Qualitative Mathematics System (Q.M.), which is a ‘symbolic system’ enabling the systematic representation of the “Disphasing Warp” and of “Realogy and of the Intonation,” and their functions. The ‘intonation’ is a data unit in Qualitative (or boundary) Mathematics/logic.

### BRIEF DESCRIPTION OF DRAWINGS

FIG. 1 Warp

This is the fundamental structure forming the fields, particles, and quanta; which functions as a wave-like entity, a slippage (or shift) zone within the all-enveloping field of “Union.”

Disphasing Warp Structure

In space-time, it is a discreet three dimensional crescent shaped elliptoid entity. It has the property of “disphasia” through the warp itself, as the slippage/shift zone moves in wave-like fashion, through the warp range, from least to greatest slippage.

FIG. 2 C.A.P. Figure

This figure indicates the Quaternary Structured Realogs/Realogy.

Warp structures flow down from the apothem (the C.A.P.) in a dextrorotatory fashion and interact with each other by linking, then by addition.

FIG. 3 Warp Stacking, Addition, and Structural Diversification: Addition and Linking

Warps first form general fields by linking, and then particle structures by addition, finally forming a roughly pyramidal shaped quarternary (four sided) entity called a Realog, a Proto Realog, to be followed by holographic stacking with others.

FIG. 4 Realog

This figure shows the basic realog structure.

FIG. 5 Realog Top and Side Views

This figure depicts the rough three dimensional form of the realog.

FIG. 6 Proto Realogs

This shows the conversion of warps “linking” in early disphasia state to “addition” in the late stage of disphasia. This occurs by holographic warp compositing (H.W.C.) in late disphasia.

FIG. 7 Disphasia Gradient and Contraqenderal Axis (C.G.A.)

This shows the direction of the process of the disphasia gradient and contragenderal axis structure (C.G.A.)—of the Realog.

FIG. 8 Disphasia Gradient Zones (Top View)

This shows the zones where fields and waves/particles occur in the disphasia gradient around the realog. The all-enveloping field of “Union” being precedent to all fields and particles, and composites of fields and particles, creates the ‘holographic nature’ of all of reality/realogy and all of its structures.

FIG. 9 Holographically Stacked Realogs

This depicts the fields of space and time, particles, and their composite structures, and all of the other known fields in a holographic relationship. Qubits and quantum entanglement occur when structures embedded in space and time fields, and other fields and particles and their composites are brought to enter back into the all-enveloping field of “Union,” which is outside of space-time. Proto Realogs and subsequent Realogs, and all the complexes and composites they make to form all of the structures of our reality, are formed in a holographic, enveloping field substructure of ‘union’.

FIG. 10 Holographic Boundary of Stacked Realogs

This shows how Proto Realogs and subsequent Realogs, and all the complexes and composites they make to form all of the structures of our reality, are being formed at the boundary of structures, within the holographic, enveloping field substructure of ‘union’. It shows Union bonded Cross Level Inversions (X.L.I.$) at the C.G.A.s.

FIG. 11 Kinetic and Potential Energy Forms

This depicts holographic energy/particle conglomerates entering holographic (electro) space, and explains the universal environment within which the claims of this patent application function. In this Figure, the sequential development of energy/ particle structures is depicted. The sequential holographic development of fields is depicted as well. It shows the mechanism of conversion between kinetic and potential forms of energy, as well as other structures and functions of realogy.

FIG. 12 Units of Intonation

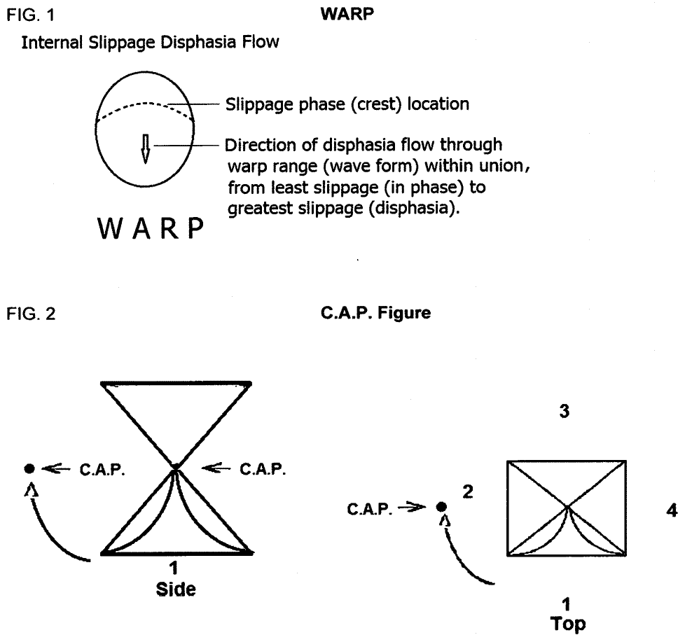

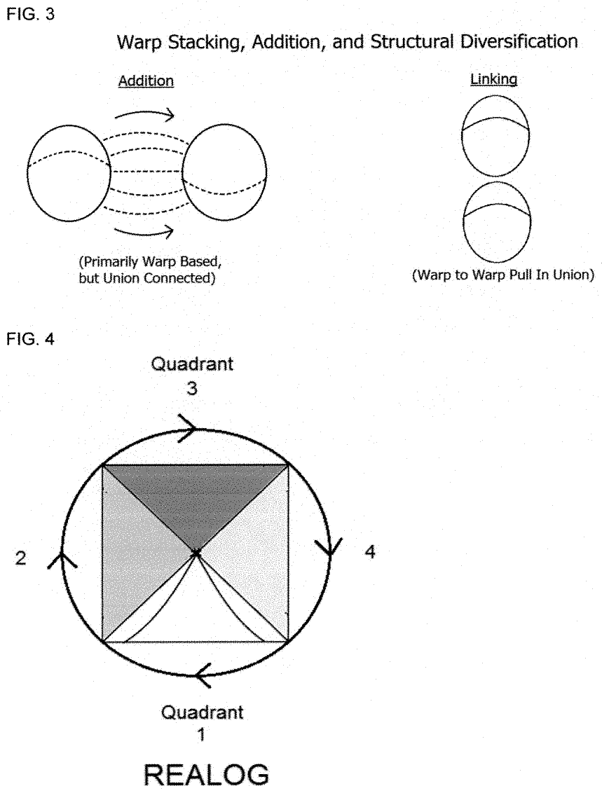

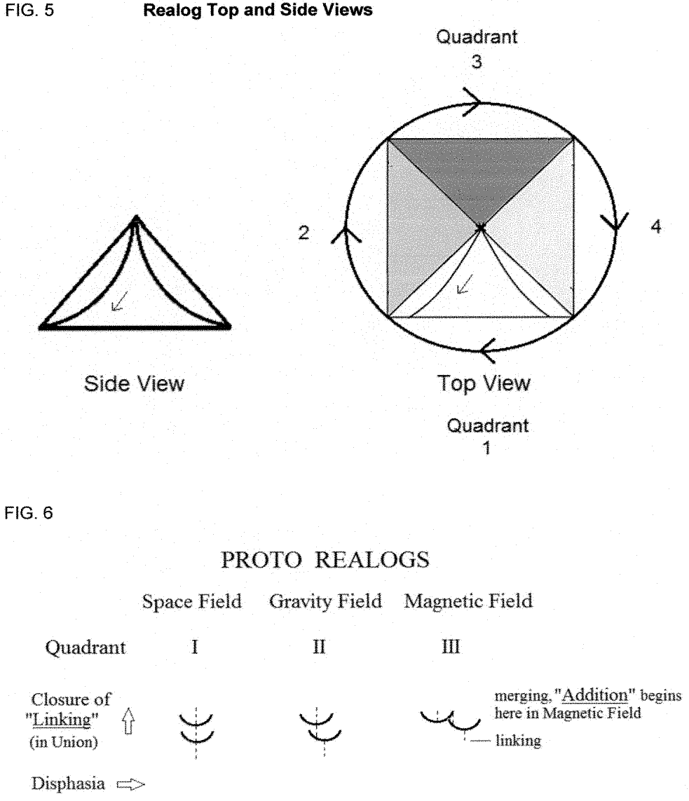

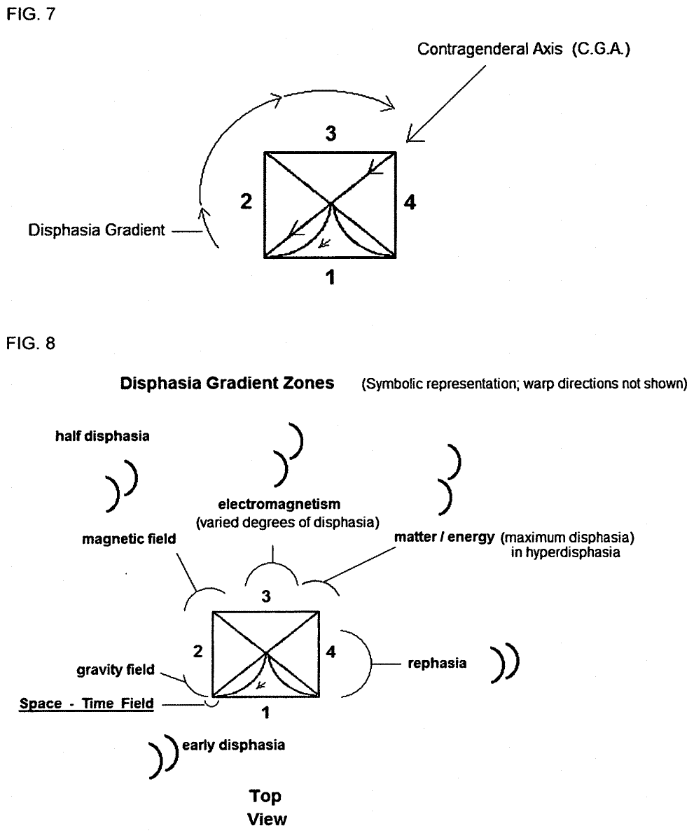

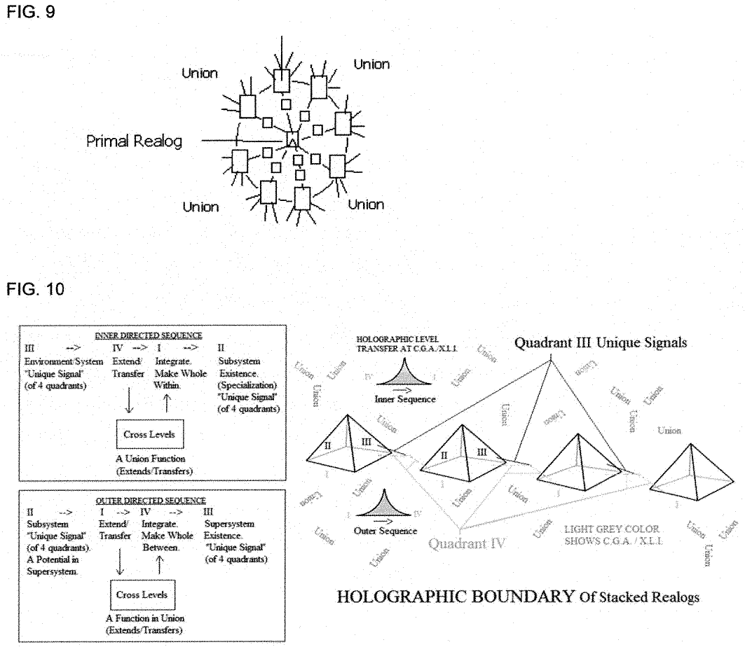

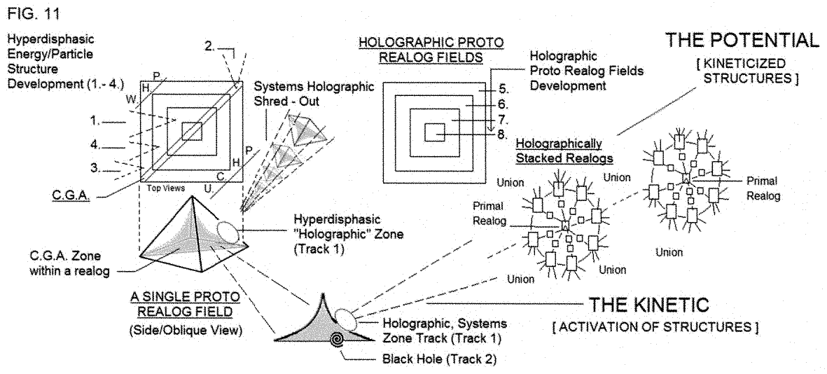

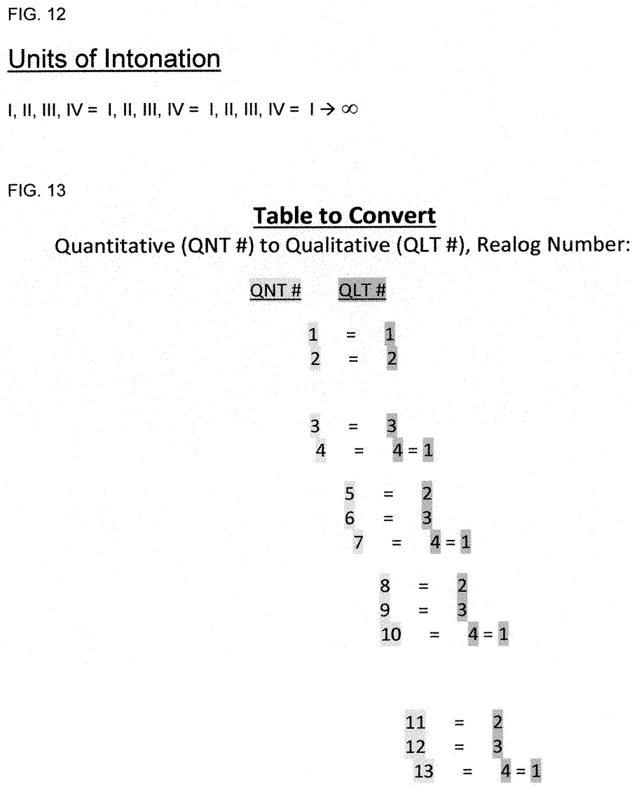

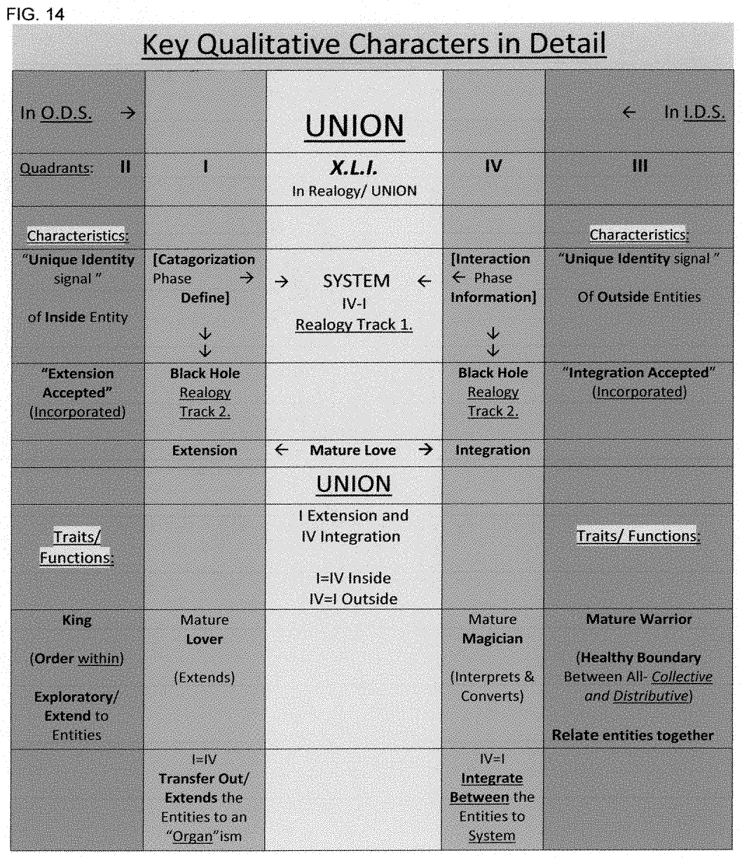

Here the data unit of intonation is representing the actual quaternary reality structure, and its unified cross boundary relationship between all structures of reality.

The Intonation is an ‘expression’ of the warp as substructure, seen throughout all of reality structure, in all fields and particles. It is a most highly integrative structure, whether in representational or functional form. It unifies. It is the basis of the holographic nature of the space-time universe, where I=IV and IV=I; but Union is its underlying and compositional structure, which is also outside/beyond that space-time reality, accounting for holographism.

Qualitative Mathematics represents qualitative characteristics of reality structures, in a sub-unit of all structures composed of four parts and its whole. That unit is the “Intonation Unit,” which can be represented as parts I, II, Ill, IV, where IV=I and I=IV, in ‘Qualitative Mathematics’. The Intonation Unit is a basic unit of data. It is also the ‘primal realog’ structure (a proto and final realog) in ‘reality structure’ itself, and is the essence of ‘reality structure’ in realogy. As such, it is the segway between the ‘representative’ in data, and the ‘actual’ in reality (such as actual qubits).

Qualitative mathematics is based on a numerical representation of the four quadrants (one, two, three, four,) of the realog, at the foundation of realogy, each number carrying the specific relational and qualitative characteristics of that quadrant with it. A core feature of that qualitative representation of observed reality is that the first quadrant (a 1) is the same realogically as the fourth quadrant (a 4), 1=4 and 4=1.

FIG. 13 Table to Convert Quantitative to Qualitative Numbers

FIG. 14 Key Qualitative Characters in Detail

### DETAILED DESCRIPTION OF THE INVENTION:

1. The structures of the “Disphasing Warps,” and 2. “Realogs/Realogy;” and 3. Intonation, a New Basic Unit for Data, and 4. the ‘symbolic system’ of “Qualitative Mathematics” each establish a basis of reliability and replicability of quantum qubits and superposition states for use with algorithms and their outputs in quantum computers. Herein, the problems of scalability, and coherence of quantum states is not an issue. Yet, the structures of “Disphasing Warps,” and “Realogs/Realogy,” could be used in existing ‘physical systems’ of quantum computers as well. Qualitative Mathematics (Q.M.) is a ‘symbolic system’, rather than a physical one, to represent and encode ideal/logical qubits and their use for any algorithm and its output. Q.M. is one answer to storing and processing quantum data reliably.

These inventions reconcile quantum mechanics with relativity, with all the implications of that reconciliation.

To distinguish it from other inventions—These inventions and their claims are distinguished by the solutions they offer to problems with other inventions/ technologies, and by the full and complete model they provide to explain and elucidate the physics underlying quantum entanglement, and the associated function of quantum bits (qubits). Other technologies with these problems are those such as:

Superconducting circuits, Trapped Ions, Silicon Spin Devices, and Topological Materials Systems, amongst others.

Specifically, there are problems with coherence and scalability with existing technologies for qubits and quantum computing. The inventions of Disphasing Warp Structure and Quaternary structured Realogs/Realogy, and Intonation, and the Qualitative Mathematics System which creates a ‘boundary logic’, or Qualitative mathematics, are all based upon a new physics model of entanglement and qubit structure and function, that is derived from observation of the structure and function of natural reality. That ‘boundary logic’ matching the real structure and function of entanglement and qubits provides a solution to the problems of coherence and scalability, that can be programmed into and built into the informational and physical structures of existing technologies and approaches for quantum computing, and qubit measurement. Generally speaking, these are the problems and solutions that these inventions address. They carry out a quantum Qualitative (or boundary) Mathematics/logic in algorithms, by this advanced method/technology of addressing superpositions. See Table below showing conversion of quantitative numbers to numbers in qualitative mathematics.

A Table Showing Quantitative Numbers Conversion to Qualitative Numbers (with Associated Qualitative Characteristics)

| | Converted to | | | |
|---|---|---|---|---|
| Quantitative Math | Qualitative Math | Qualitative | | |
| (QNT #) → | (QLT #) | Characteristics | | |
| 1 | 1 | 1 is ‘extension’ | transfer signal out of | categorize/ |
| | | | (entity/organism) | elementize |
| 2 | 2 | 2 is ‘explore’ | signal of entity/identity | order (within) |
| 3 | 3 | 3 is ‘relate | identity signal of outside | healthy |
| | | entities | entities | boundary |
| | | together’ | | (between all) |
| 4 | 4 = 1 | 4 is ‘integrate | interprets and converts | interaction of |
| | | between | | entities |
| | | entities’ | | |
| 5 | 2 | | | |
| 6 | 3 | | | |
| 7 | 4 = 1 | | | |
| 8 | 2 | | | |
| 9 | 3 | | | |
| 0 or 10 | 4 = 1 | | | |

The real structure and function of superpositions and entanglement, and therefore quantum bits is: All structures and functions of reality are composed of and connected to a substrate (Union) that is before (more primal to) as well as outside of (beyond) the energy/particle structures, and also the field structures of reality. Therefore, all of these structures are permanently entangled within that substrate (Union). Accessing that connected state is what entanglement is. In FIG. 11, of the Drawings, the sequential Development of Energy/Particle Structures is depicted, using the term ‘electro’ before each structure, which means that it is connected to that underlying substrate (i.e. a holographic state). Each energy/particle structure is a holographic, or substrate embedded, “quaternary (four part) cross-levels” connection (a qxlit, or qxldigit) structure (a unit of Intonation Data in Qualitative Mathematics, based upon the universal Realog structure of reality). Each of these structures are formed at a different level of holographic reality structure called Proto Realogs. These particles, or quanta, are expressions within their own Proto Realog Field. Their sequential development (which occurs holographically in the C.G.A.) shown in FIG. 11 is: 1. ‘Electro’ Magnetism, 2. ‘Electro’ Nucleonism, 3. ‘Electro’ Spacism, 4. ‘Electro’ Gravitism. The sequential development of Holographic Proto Realog Fields is shown in FIG. 11 as well, and is: 5. Space Field, 6. Gravity Field, 7. Magnetic Field, 8. Nucleon Field. FIG. 11 also depicts other structures and functions not necessary for purposes of describing these inventions. (Please ignore these structures.)

This representational and actual relational model and understanding of entanglement in reality structure can be used as described above to solve the problems currently associated with quantum computers and qubit measurement.

Additional detail describing the operations of these solutions are found in the Brief Description of Drawings and the accompanying Drawings that I have provided.

### Independent Claim

1. The Disphasing Warp Structure is an invention/discovery that is a substructure to all fields and particles and quanta.
Dependent Claims

2. Quaternary structured “Realogs/Realogy” is an invention/discovery which is a structure that assembles all warp structures that make up fields and particles and their complexes, holographically by a unifying field.
This claim depends on the existence and function of claim 1., the “Disphasing Warp Structure.”

3. Intonation, New Basic Unit for Data, is an invention/ discovery that reflects and is the ‘four part structure’ of fields and particles and quantum reality.
This claim is dependent on the existence and function of dependent claim 2., and therefore also on its dependency to the “Disphasing Warp Structure” (claim 1.).
Independent Claim

4. Qualitative Mathematics System is a symbolic system representing the Disphasing Warp and Realogy.
